(19) United States
(12) Patent Application Publication
(10) Pub. No.: US 2011/0203910 A1
(43) Pub. Date: Aug. 25, 2011

(54) SWITCH APPARATUS

(75) Inventors: Toshitaka MIWA, Miyagi-Ken (JP); Takashi FUJIKI, Miyagi-Ken (JP)

(73) Assignee: ALPS ELECTRIC CO., LTD., Tokyo (JP)

(21) Appl. No.: 13/024,857

(22) Filed: Feb. 10, 2011

(30) Foreign Application Priority Data
Feb. 23, 2010 (JP) 2010-037591

(51) Int. Cl. H01H 15/02

(52) U.S. Cl. 200/16 R

(57) ABSTRACT

A switch apparatus includes first, second, third, and fourth movable contacts held by a slider and sliding on a circuit board in conjunction with the rotational operation of an operation knob, and a belt-like common fixed contact, an auto fixed contact, a down fixed contact, and an up fixed contact provided on the circuit board. The auto fixed contact, down fixed contact, and up fixed contact are distributed on a straight line parallel to the common fixed contact. The third and fourth movable contacts are normally in sliding contact with the common fixed contact.

### CLAIM OF PRIORITY

This application claims benefit of Japanese Patent Application No. 2010-037591 filed on Feb. 23, 2010, which is hereby incorporated by reference.

### BACKGROUND OF THE INVENTION

1. Field of the Invention

The present invention relates to a switch apparatus for causing an automotive power window to open and close, and more specifically, it relates to a contact structure of a switch apparatus with which a manual down/up operation and an auto down/up operation of a power window can be selectively performed.

2. Description of the Related Art

This type of power window opening and closing switch apparatus is often disposed, for example, on the inner side of the driver side door of an automobile, and is provided with an operation knob that is rockably supported and on which a push operation and a pull operation can be selectively performed, and a detecting means that detects whether or not a predetermined push operation or pull operation is performed on the operation knob. In a typical example of such a detecting means, movable contacts that slide in conjunction with the rocking of the operation knob is brought into and out of contact with fixed contacts on a circuit board.

FIG. 14 is an explanatory view showing a contact structure in a known power window opening and closing switch apparatus (see, for example, Japanese Unexamined Patent Application Publication No. 2008-4322). In the figure, a common fixed contact 31, a manual down fixed contact 32, a manual up fixed contact 33, an auto down fixed contact 34, and an auto up fixed contact 35 are disposed on a circuit board 30, and first to fourth movable contacts 36a to 36d are provided on a slider segment (slider) 36 formed of a conductive metal plate. A driving portion is provided in an operation knob (not shown). When this operation knob is rocked (pushed or pulled), the slider segment 36 driven by the driving portion slides along the circuit board 30. Therefore, the movable contacts 36a to 36d can be brought into and out of contact with the common fixed contact 31 and any one of the other fixed contacts. However, in a neutral state (unoperated state) where the operation knob is not operated, the slider segment 36 is disposed at a neutral position shown in FIG. 14, and therefore the movable contacts 36a to 36d are all out of contact with the fixed contacts 31 to 35. According to the slide position of the slider segment 36, the first movable contact 36a can be brought into and out of contact with the fixed contacts 31 and 32, the second movable contact 36b can be brought into and out of contact with the fixed contacts 31 and 33, the third movable contact 36c can be brought into and out of contact with the fixed contacts 31 and 34, and the fourth movable contact 36d can be brought into and out of contact with the fixed contacts 31 and 35.

That is to say, when the slider segment 36 is at the neutral position shown in FIG. 14, the common fixed contact 31 is not electrically connected with any of the fixed contacts 32 to 35, and therefore a command signal that rotationally drives a power window drive motor is not output. However, with the pushing of the operation knob, the slider segment 36 slides downward in FIG. 14. Therefore, by rotating the operation knob to a halfway pushed position, the switch apparatus can be brought into a state where the first movable contact 36a is in contact with the manual down fixed contact 32, the fourth movable contact 36d is in contact with the common fixed contact 31, and the second movable contact 36b and the third movable contact 36c are out of contact with the fixed contacts 31 and 34, respectively. Thus, the manual down fixed contact 32 and the common fixed contact 31 are electrically connected with each other through the slider segment 36, and therefore a command signal is output that causes the power window to perform opening operation, and the motor is driven in the forward direction. When the operation force is removed in this state, the operation knob is automatically returned to the neutral position shown in FIG. 14 by the elastic force of a return spring (not shown), and therefore the opening operation of the power window stops. By rotating the operation knob to a fully pushed position, the switch apparatus can be brought into a state where the third movable contact 36c is in contact with the auto down fixed contact 34 and the second movable contact 36b is in contact with the common fixed contact 31. Thus, the auto down fixed contact 34 and the common fixed contact 31 are electrically connected with each other through the slider segment 36, and therefore a command signal is output that causes the power window to open fully, and the motor is driven in the reverse direction until the power window opens fully.

On the other hand, with the pulling of the operation knob, the slider segment 36 slides upward in FIG. 14. Therefore, by rotating the operation knob to a halfway pulled position, the switch apparatus can be brought into a state where the second movable contact 36b is in contact with the manual up fixed contact 33, the third movable contact 36c is in contact with the common fixed contact 31, and the first movable contact 36a and the fourth movable contact 36d are out of contact with the fixed contacts 31 and 35, respectively. Thus, the manual up fixed contact 33 and the common fixed contact 31 are electrically connected with each other through the slider segment 36, and therefore a command signal is output that causes the power window to perform closing operation, and the motor is driven in the reverse direction. When the operation force is removed in this state, the operation knob is automatically returned to the neutral position shown in FIG. 14, and therefore the closing operation of the power window stops. By rotating the operation knob to a fully pulled position, the switch apparatus can be brought into a state where the first movable contact 36a is in contact with the common fixed contact 31 and the fourth movable contact 36d is in contact with the auto up fixed contact 35. Thus, the auto up fixed contact 35 and the common fixed contact 31 are electrically connected with each other through the slider segment 36, and therefore a command signal is output that causes the power window to close fully, and the motor is driven in the reverse direction until the power window closes fully.

In the known power window opening and closing switch apparatus having such a contact structure, the common fixed contact 31 is substantially equidistant from the four fixed contacts 32 to 35. Therefore, four types of signals (a manual down command signal, an auto down command signal, a manual up command signal, and an auto up command signal) according to the pushing and pulling of the operation knob can be reliably derived. In addition, because all of the fixed contacts 31 to 35 can be disposed in an elongate region on the circuit board 30, the switch apparatus 1 has a good space factor and can be easily reduced in size.

However, in the case of a power window opening and closing switch apparatus in which five fixed contacts 31 to 35 are distributed on a circuit board 30 as in the above-described known switch apparatus, wiring patterns for the five fixed contacts 31 to 35 need to be formed on the circuit board 30. For this reason, the wiring layout on the circuit board 30 tends to be complex and dense. This limits the degree of freedom of circuit design and increases the manufacturing cost.

### SUMMARY OF THE INVENTION

The present invention provides a power window opening and closing switch apparatus that has a small number of fixed contacts and is easy to design and manufacture.

In an aspect of the present invention, a switch apparatus includes an operation knob supported rockably and capable of being pushed and pulled, a circuit board having a plurality of fixed contacts disposed thereon, a slider moving linearly in conjunction with the rocking of the operation knob, and a plurality of movable contacts held by the slider. The switch apparatus can output signals causing an automotive power window to open and close, by bringing the movable contacts into and out of contact with the fixed contacts with the movement of the slider. The plurality of fixed contacts include an auto fixed contact, a down fixed contact located at a distance from the auto fixed contact on one side of the direction of movement of the slider, an up fixed contact located at a distance from the auto fixed contact on the other side of the direction of movement of the slider, and a common fixed contact located at least at the side of the auto fixed contact and at a distance therefrom and extending in the direction of movement of the slider. The plurality of movable contacts include a first movable contact capable of being brought into and out of contact with the auto fixed contact and the down fixed contact, a second movable contact capable of being brought into and out of contact with the auto fixed contact and the up fixed contact, and normally-closed movable contacts normally in sliding contact with the common fixed contact.

From a power window opening and closing switch apparatus having such a contact structure, four types of signals (a manual down command signal, an auto down command signal, a manual up command signal, and an auto up command signal) according to the pushing and pulling of the operation knob can be reliably derived, by bringing the movable contacts held by the slider into and out of contact with the four fixed contacts that can be compactly disposed on the circuit board. Therefore, the switch apparatus has a good space factor and can be easily reduced in size. In addition, because the number of fixed contacts is four and only four wiring patterns are required, the wiring layout on the circuit board can be simplified. Therefore, the degree of freedom of circuit design can be improved, and the manufacturing cost can be reduced.

It is preferable that when the operation knob is not operated, the distance between the first movable contact and the down fixed contact be set smaller than the distance between the second movable contact and the auto fixed contact, and the distance between the second movable contact and the up fixed contact be set smaller than the distance between the first movable contact and the auto fixed contact; when the operation knob is pushed, a manual down command signal be output by bringing the first movable contact into contact with the down fixed contact with the second movable contact out of contact with the auto fixed contact, and an auto down command signal be output by bringing the second movable contact into contact with the auto fixed contact with the first movable contact in contact with the down fixed contact; and when the operation knob is pulled, a manual up command signal be output by bringing the second movable contact into contact with the up fixed contact with the first movable contact out of contact with the auto fixed contact, and an auto up command signal be output by bringing the first movable contact into contact with the auto fixed contact with the second movable contact in contact with the up fixed contact.

It is preferable that the auto fixed contact be provided at a position equidistant from the down fixed contact and the up fixed contact, and the first movable contact and the second movable contact be disposed at positions equidistant from the auto fixed contact when the operation knob is not operated. In this case, the contact structure can be extremely simplified, and therefore the timing to derive the first to fourth signals can be easily set with a high degree of accuracy.

It is preferable that the common fixed contact extend from the side of the down fixed contact to the side of the up fixed contact, the normally-closed movable contacts include a third movable contact and a fourth movable contact, and the third and fourth movable contacts and the first and second movable contacts be distributed substantially at the four corners of a rectangle. In this case, the slider can be easily slid in a stable position relative to the circuit board.

### BRIEF DESCRIPTION OF THE DRAWINGS

FIG. 1 is an external view of a switch unit including a switch apparatus according to an embodiment of the present invention;

FIG. 2 is an explanatory view showing a neutral state of the switch apparatus;

FIG. 3 is an explanatory view showing a manual down command state of the switch apparatus;

FIG. 4 is an explanatory view showing an auto down command state of the switch apparatus;

FIG. 5 is an explanatory view showing a manual up command state of the switch apparatus;

FIG. 6 is an explanatory view showing an auto up command state of the switch apparatus;

FIG. 7 is an explanatory view showing the positions of movable contacts of the switch apparatus in the neutral state;

FIG. 8 is an equivalent circuit schematic corresponding to FIG. 7;

FIG. 9 is an explanatory view showing the positions of movable contacts of the switch apparatus in the manual down command state;

FIG. 10 is an equivalent circuit schematic corresponding to FIG. 9;

FIG. 11 is an explanatory view showing the positions of movable contacts of the switch apparatus in the auto down command state;

FIG. 12 is an equivalent circuit schematic corresponding to FIG. 11;

FIG. 13 shows the voltage levels of signals input from fixed contacts of the switch apparatus into a CPU in each operation state; and

FIG. 14 is an explanatory view showing the positions of movable contacts of a known switch apparatus in a neutral state.

### DESCRIPTION OF THE PREFERRED EMBODIMENTS

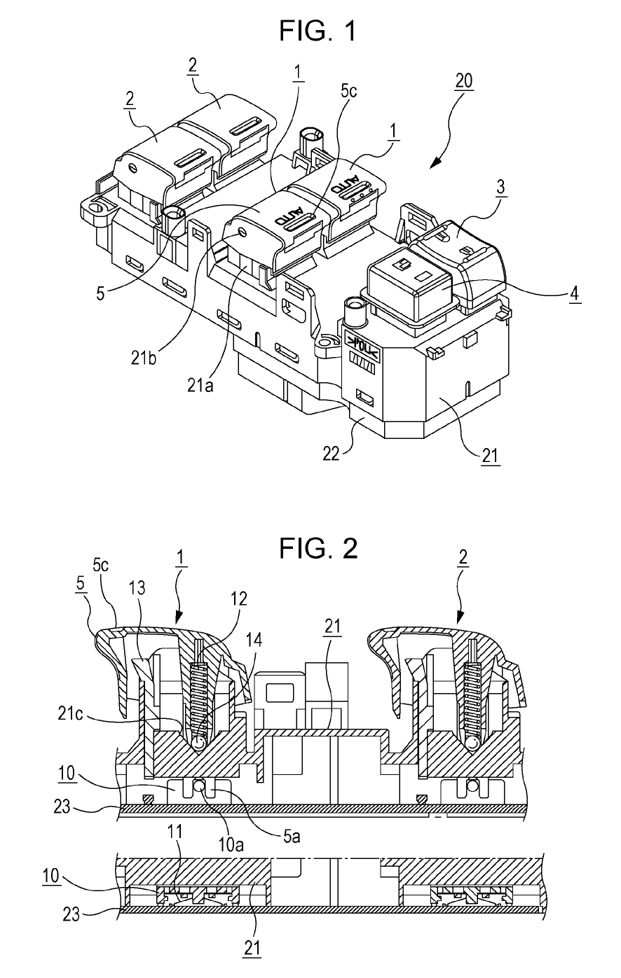

A switch apparatus 1 according to an embodiment of the present invention will be described. As shown in FIG. 1, this switch apparatus 1 is incorporated in a switch unit 20. The switch unit 20 is placed on the inner side of the driver side door of an automobile and includes two types of switch apparatuses 1 and 2 for opening and closing a power window, a switch apparatus 3 for locking and unlocking the door, and a switch apparatus 4 for locking and unlocking the power window. The outer shell of the switch unit 20 includes a case 21 on the upper side of which operation knobs of the switch apparatuses 1 to 4 are disposed, and a cover body 22 that covers a lower opening of the case 21. A circuit board 23 placed on the cover body 22 is housed in the case 21 (see FIGS. 2 to 6).

Of the two types of switch apparatuses 1 and 2 for opening and closing the power window, the switch apparatuses 1 according to this embodiment can output manual command signals and auto command signals, whereas the switch apparatuses 2, to which the present invention is not applicable, can output only manual command signals. The present invention is not applicable to the other switch apparatuses 3 and 4 not for opening and closing the power window, either. So, the description of the switch apparatuses 2 to 4 will be omitted.

A switch apparatus 1 according to this embodiment will be described with reference to FIGS. 1 to 13. This switch apparatus 1 mainly includes an operation knob 5 rockably supported by a pair of vertical walls 21a of the case 21, four fixed contacts 6 to 9 disposed on the circuit board 23, a slider 10 that slides linearly in the longitudinal direction of the circuit board 23 in conjunction with the rocking of the operation knob 5, a slider segment 11 that is held on the bottom surface of the slider 10 and slides on the circuit board 23, a coil spring 12 incorporated in the operation knob 5 as a return spring, and a light guide 13 incorporated between the pair of vertical walls of the case 21 in order to illuminate the operation knob 5. In each of FIGS. 2 to 6, the upper part shows the positional relationship between the operation knob 5 and the slider 10, and the lower part shows the positional relationship between the circuit board 23 and the slider 10.

A supporting shaft 21b projects from each of the vertical walls of the case 21 and rockably supports the operation knob 5. The case 21 has a V-shaped groove-like cam surface 21c formed between the pair of vertical walls 21a. As shown in FIG. 2, the cam surface 21c is normally in elastic contact with a steel ball 14 urged by the coil spring 12.

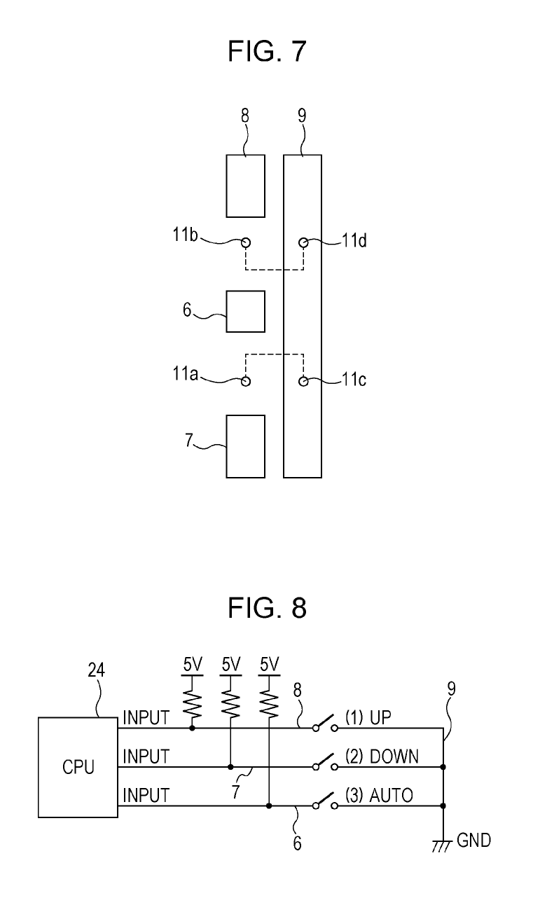

As shown in FIG. 7, on the circuit board 23 are formed an auto fixed contact 6, a down fixed contact 7, an up fixed contact 8, and a common fixed contact 9 as fixed contacts for the switch apparatus 1. The auto fixed contact 6 is located midway between the down fixed contact 7 and the up fixed contact 8. The three fixed contacts 6 to 8 are lined up along the longitudinal direction of the circuit board 23 (the sliding direction of the slider 10). That is to say, the down fixed contact 7 is located at a distance from the auto fixed contact 6 on one side of the sliding direction of the slider 10, the up fixed contact 8 is located at a distance from the auto fixed contact 6 on the other side of the sliding direction of the slider 10, and the distance between the fixed contacts 6 and 7 is equal to the distance between the fixed contacts 6 and 8. At the side of the three fixed contacts 6 to 8 is provided a belt-like common fixed contact 9 extending along the sliding direction of the slider 10. The distances between the common fixed contact 9 and the fixed contacts 6 to 8 are equal. As shown in FIG. 8, the common fixed contact 9 is a grounded conductor portion, and a predetermined voltage (for example, 5 V) is applied to each of the other three fixed contacts 6 to 8.

The operation knob 5 is rotatable around the supporting shaft 21b of the case 21. A two-step push operation and a two-step pull operation can be selectively performed. The operation knob 5 has a U-shaped driving portion 5a that projects downward and slidably engages with the shaft portion 10a of the slider 10, and a cylindrical recessed portion 5b that houses the coil spring 12. In the upper wall portion of the operation knob 5 is provided an illuminated portion 5c that can be illuminated by the light guide 13. When the operation knob 5 is rotated (pushed or pulled), the steel ball 14 compresses the coil spring 12 in the cylindrical recessed portion 5b while moving upward along the cam surface 21c. When the operation force is removed, the steel ball 14 is pushed back by the elastic force of the coil spring 12 to the valley portion of the cam surface 21c, and the operation knob 5 is automatically returned to the neutral position shown in FIG. 2.

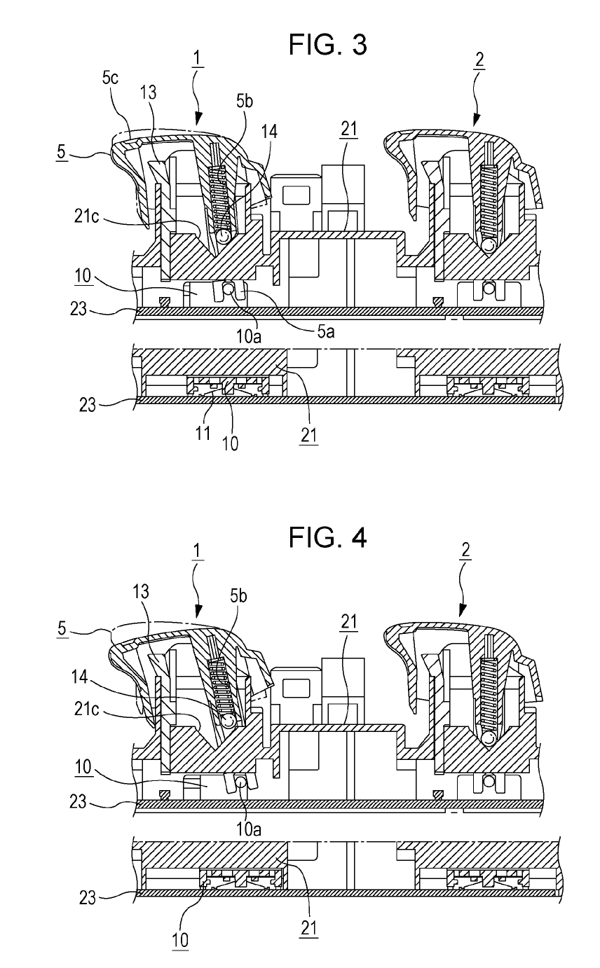

The slider 10 has a shaft portion 10a projecting from the side surface thereof, and the shaft portion 10a is slidably engaged with the driving portion 5a of the operation knob 5. Therefore, as shown in FIGS. 3 to 6, when the operation knob 5 is rotated, the shaft portion 10a is driven by the driving portion 5a and slides in the left-right direction in the figure. Therefore, in conjunction with the rocking of the operation knob 5, the slider 10 slides linearly along the circuit board 23.

The slider segment 11 is formed of a single conductive metal plate. At the four corners of the slider segment 11, first to fourth movable contacts 11a to 11d are provided. The slider segment 11 slides integrally with the slider 10 with the movable contacts 11a to 11d in sliding contact with the circuit board 23. At that time, the first and second movable contacts 11a and 11b slide on a straight line connecting the three fixed contacts 6 to 8, and the third and fourth movable contacts 11c and 11d slide on the belt-like common fixed contact 9. That is to say, the third and fourth movable contacts 11c and 11d are normally in sliding contact with the common fixed contact 9 and grounded, and therefore the third and fourth movable contacts 11c and 11d will hereinafter be collectively referred to as normally-closed movable contact. The first movable contact 11a can be brought into and out of contact with the auto fixed contact 6 and the down fixed contact 7, and the second movable contact 11b can be brought into and out of contact with the auto fixed contact 6 and the up fixed contact 8. In the case of this embodiment, the first and third movable contacts 11a and 11c are not electrically connected with the second and fourth movable contacts 11b and 11d. However, if the first and third movable contacts 11a and 11c are electrically connected with the second and fourth movable contacts 11b and 11d, the same function can be achieved.

The positional relationship between the first and second movable contacts 11a and 11b and the fixed contacts 6 to 8 will be described. In a neutral state where the operation knob 5 is not operated, the first movable contact 11a is located between the fixed contacts 6 and 7 and the second movable contact 11b is located between the fixed contacts 6 and 8 as shown in FIG. 7. That is to say, the movable contacts 11a and 11b are out of contact with any of the fixed contacts 6 to 8. The movable contacts 11a and 11b are disposed symmetrically with respect to the auto fixed contact 6. At this time, the distance between the first movable contact 11a and the down fixed contact 7 is smaller than the distance between the second movable contact 11b and the auto fixed contact 6. Similarly, the distance between the second movable contact 11b and the up fixed contact 8 is smaller than the distance between the first movable contact 11a and the auto fixed contact 6.

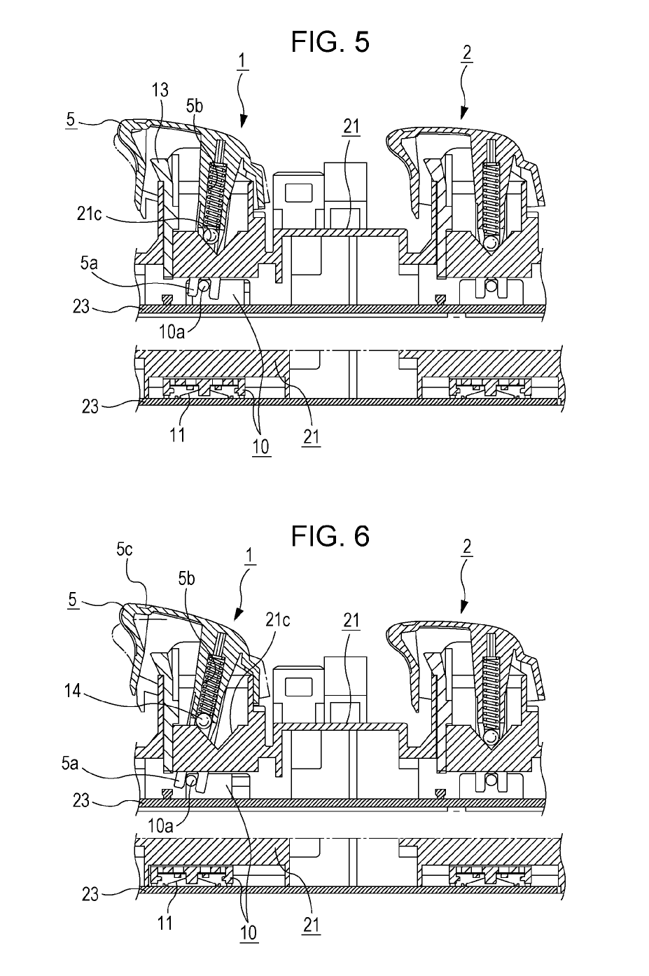

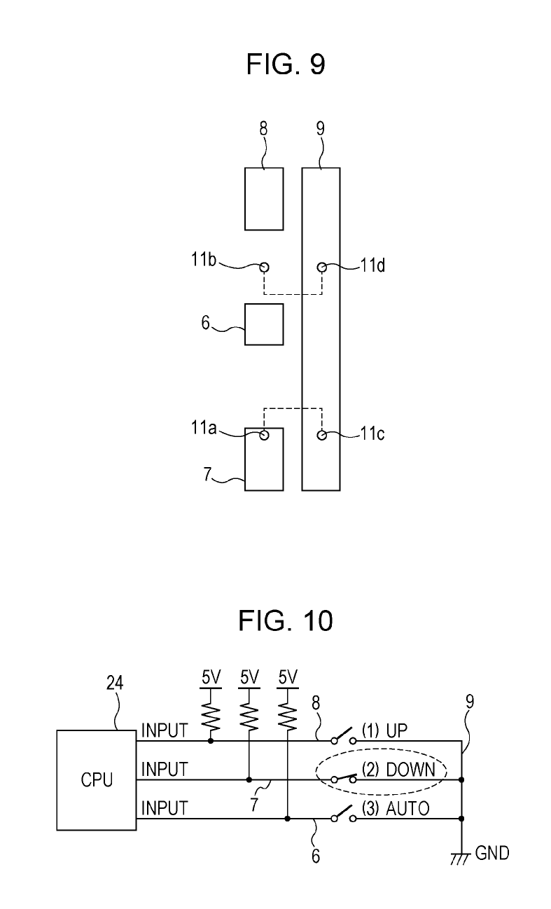

However, when the operation knob 5 is rotated (pushed or pulled), the slider segment 11 slides integrally with the slider 10, and therefore four types of signals can be derived by bringing the first movable contact 11a and the second movable contact 11b into contact with the fixed contacts 6 to 8. When the operation knob 5 is pushed, the slider segment 11 slides to the down fixed contact 7 side. When the operation knob 5 is pulled, the slider segment 11 slides to the up fixed contact 8 side. Therefore, for example, by rotating the operation knob 5 to the halfway pushed position shown in FIG. 3, the first movable contact 11a can be brought into contact with the down fixed contact 7 with the second movable contact 11b out of contact with the auto fixed contact 6 as shown in FIG. 9. Thus, the down fixed contact 7 is electrically connected through the slider segment 11 with the common fixed contact 9, and therefore a first signal (manual down command signal) can be derived. Similarly, by rotating the operation knob 5 to the halfway pulled position shown in FIG. 5, the second movable contact 11b can be brought into contact with the up fixed contact 8 with the first movable contact 11a out of contact with the auto fixed contact 6. Thus, the up fixed contact 8 is electrically connected through the slider segment 11 with the common fixed contact 9, and therefore a second signal (manual up command signal) can be derived.

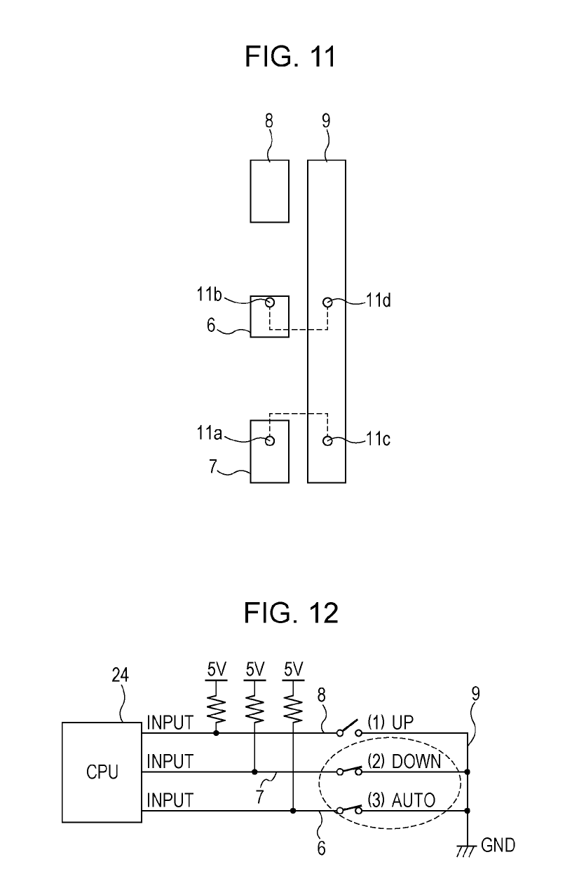

By rotating the operation knob 5 to the fully pushed position shown in FIG. 4, the second movable contact 11b can be brought into contact with the auto fixed contact 6 with the first movable contact 11a in contact with the down fixed contact 7 as shown in FIG. 11. Thus, both the auto fixed contact 6 and the down fixed contact 7 are electrically connected through the slider segment 11 with the common fixed contact 9, and therefore a third signal (auto down command signal) can be derived. Similarly, by rotating the operation knob 5 to the fully pulled position shown in FIG. 6, the first movable contact 11a can be brought into contact with the auto fixed contact 6 with the second movable contact 11b in contact with the up fixed contact 8. Thus, both the auto fixed contact 6 and the up fixed contact 8 are electrically connected through the slider segment 11 with the common fixed contact 9, and therefore a fourth signal (auto up command signal) can be derived.

Next, the operation of the switch apparatus 1 configured as above will be described. When the operation knob 5 is in a neutral state where the operation knob 5 is not operated, the slider 10 and the slider segment 11 are disposed at their neutral positions shown in FIG. 2. At this time, the first and second movable contacts 11a and 11b are out of contact with any of the fixed contacts 6 to 8, and therefore, as shown in FIG. 7, the common fixed contact 9 is not electrically connected with the fixed contacts 6 to 8. Therefore, the equivalent circuit of the switch apparatus 1 is as shown in FIG. 8, and the voltage levels of the signals input from the fixed contacts 6 to 8 into a CPU (Central Processing Unit) 24 are all High (5 V). This state is such a state where the switch apparatus 1 does not output a command signal that rotationally drives the power window drive motor.

However, when the operation knob 5 is pushed halfway and thereby rotated to the halfway pushed position as shown in FIG. 3, the slider segment 11 slides a predetermined distance to the down fixed contact 7 side, and the switch apparatus 1 is brought into a state where, as shown in FIG. 9, the first movable contact 11a is in contact with the down fixed contact 7 and the second movable contact 11b does not reach the auto fixed contact 6. Thus, the down fixed contact 7 is electrically connected through the slider segment 11 with the common fixed contact 9, and therefore the equivalent circuit of the switch apparatus 1 is as shown in FIG. 10, and the voltage level of the signal input from the down fixed contact 7 into the CPU 24 switches to Low (0 V). However, the voltage levels of the signals input from the fixed contacts 6 and 8 into the CPU 24 remain High (5 V). This state is such a state where the switch apparatus 1 outputs a first signal (manual down command signal). The first signal drives the motor in the forward direction and thereby the power window performs opening operation. When the operation force is removed in this state, the steel ball 14 is pushed back to the valley portion of the cam surface 21c and thereby the operation knob 5 is automatically returned to the neutral position shown in FIG. 2 as described above. Therefore, the opening operation of the power window stops.

When the operation knob 5 is pushed fully and thereby rotated to the fully pushed position as shown in FIG. 4, the slider segment 11 slides further to the down fixed contact 7 side, and the switch apparatus 1 is brought into a state where, as shown in FIG. 11, the first movable contact 11a is in contact with the down fixed contact 7 and the second movable contact 11b is in contact with the auto fixed contact 6. Thus, the down fixed contact 7 and the auto fixed contact 6 are electrically connected through the slider segment 11 with the common fixed contact 9, and therefore the equivalent circuit of the switch apparatus 1 is as shown in FIG. 12, and the voltage levels of the signals input from the down fixed contact 7 and the auto fixed contact 6 into the CPU 24 switch to Low (0 V). This state is such a state where the switch apparatus 1 outputs a third signal (auto down command signal). The third signal drives the motor in the forward direction until the power window opens fully. That is to say, once the third signal is output from the switch apparatus 1, the power window continues opening operation until the power window opens fully, even if the operation force is removed and the operation knob 5 is automatically returned to the neutral position.

The operation at the time of the pull operation is basically the same as the operation at the time of the push operation. That is to say, when the operation knob 5 is pulled halfway and thereby rotated to the halfway pulled position as shown in FIG. 5, the slider segment 11 slides a predetermined distance to the up fixed contact 8 side, and the switch apparatus 1 is brought into a state where the second movable contact 11b is in contact with the up fixed contact 8 and the first movable contact 11a does not reach the auto fixed contact 6. Thus, the up fixed contact 8 is electrically connected through the slider segment 11 with the common fixed contact 9, and therefore the voltage level of the signal input from the up fixed contact 8 into the CPU 24 switches to Low. This state is such a state where the switch apparatus 1 outputs a second signal (manual up command signal). The second signal drives the motor in the reverse direction, and therefore the power window performs closing operation. In this case, when the operation force is removed, the operation knob 5 is automatically returned to the neutral position, and therefore the closing operation of the power window stops.

When the operation knob 5 is pulled fully and thereby rotated to the fully pulled position as shown in FIG. 6, the slider segment 11 slides further to the up fixed contact 8 side, and the switch apparatus 1 is brought into a state where the second movable contact 11b is in contact with the up fixed contact 8 and the first movable contact 11a is in contact the auto fixed contact 6. Thus, the up fixed contact 8 and the auto fixed contact 6 are electrically connected through the slider segment 11 with the common fixed contact 9, and therefore the voltage levels of the signals input from the up fixed contact 8 and the auto fixed contact 6 into the CPU 24 switch to Low. This state is such a state where the switch apparatus 1 outputs a fourth signal (auto up command signal). The fourth signal drives the motor in the reverse direction until the power window closes fully. That is to say, once the fourth signal is output from the switch apparatus 1, the power window continues closing operation until the power window closes fully, even if the operation force is removed and the operation knob 5 is automatically returned to the neutral position.

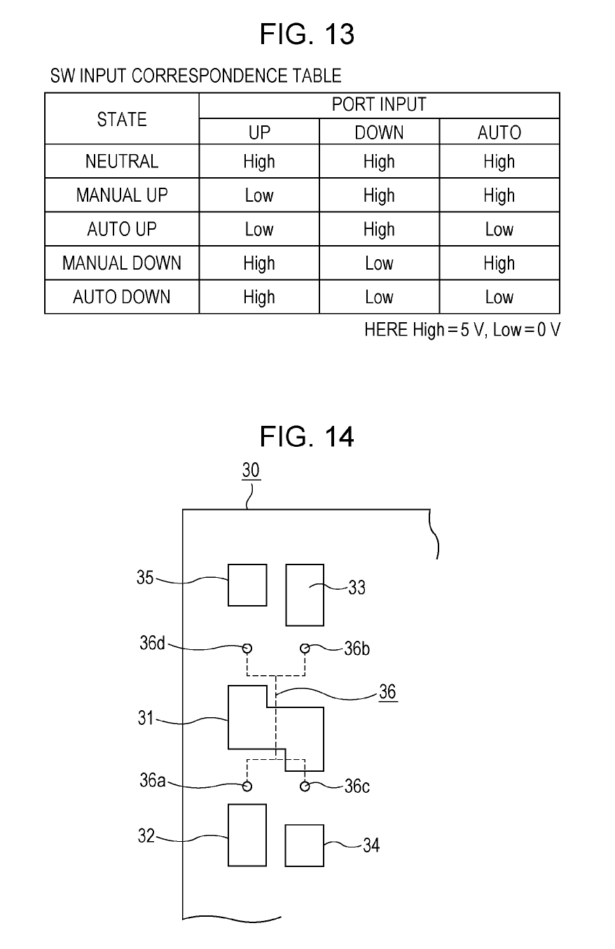

The voltage levels of signals input from the fixed contacts 6 to 8 of the switch apparatus 1 into the CPU 24 in each operation state are tabulated in FIG. 13. The switch apparatus 1 is configured so that when the operation knob 5 is rotated to a predetermined pushed or pulled position, the steel ball 14 crosses the edge of the cam surface 21c and thereby a clicking sensation is produced.

As described above, from the power window opening and closing switch apparatus 1 according to this embodiment, four types of signals (a manual down command signal, an auto down command signal, a manual up command signal, and an auto up command signal) according to the pushing and pulling of the operation knob 5 can be reliably derived, by bringing the movable contacts (first movable contact 11a, second movable contact 11b, and normally-closed movable contacts 11c and 11d) of the slider segment 11 held by the slider 10 into contact with the four fixed contacts (auto fixed contact 6, down fixed contact 7, up fixed contact 8, and common fixed contact 9) that can be compactly disposed on the circuit board 23. Therefore, the switch apparatus 1 has a good space factor and can be easily reduced in size. In addition, because the number of fixed contacts is four and only four wiring patterns are required, the wiring layout on the circuit board 23 can be simplified.

In the switch apparatus 1, the auto fixed contact 6 is provided at a position equidistant from the down fixed contact 7 and the up fixed contact 8, and the first movable contact 11a and the second movable contact 11b are disposed at positions equidistant from the auto fixed contact 6 when the operation knob 5 is not operated. Therefore, the contact structure is extremely simple, and the timing to derive the first to fourth signals can be easily set with a high degree of accuracy.

By changing the shape of the slider segment 11, the common fixed contact 9 can be made shorter than in the above embodiment. However, when the common fixed contact 9 extends from the side of the down fixed contact 7 to the side of the up fixed contact 8, and when the first and second movable contacts 11a and 11b and the third and fourth movable contacts 11c and 11d that are normally-closed movable contacts are distributed substantially at the four corners of a rectangle, the slider 10 can be easily slid in a stable position relative to the circuit board 23.

What is claimed is:

1. A switch apparatus comprising:
an operation knob supported rockably and capable of being pushed and pulled;
a circuit board having a plurality of fixed contacts disposed thereon;
a slider moving linearly in conjunction with the rocking of the operation knob; and
a plurality of movable contacts held by the slider,
the switch apparatus being able to output signals causing an automotive power window to open and close, by bringing the movable contacts into and out of contact with the fixed contacts with the movement of the slider,
wherein the plurality of fixed contacts include:
an auto fixed contact;
a down fixed contact located at a distance from the auto fixed contact on one side of the direction of movement of the slider;
an up fixed contact located at a distance from the auto fixed contact on the other side of the direction of movement of the slider; and
a common fixed contact located at least at the side of the auto fixed contact and at a distance therefrom and extending in the direction of movement of the slider, and
the plurality of movable contacts include:
a first movable contact capable of being brought into and out of contact with the auto fixed contact and the down fixed contact;
a second movable contact capable of being brought into and out of contact with the auto fixed contact and the up fixed contact; and
normally-closed movable contacts normally in sliding contact with the common fixed contact.

2. The switch apparatus according to claim 1, wherein when the operation knob is not operated, the distance between the first movable contact and the down fixed contact is set smaller than the distance between the second movable contact and the auto fixed contact, and the distance between the second movable contact and the up fixed contact is set smaller than the distance between the first movable contact and the auto fixed contact; when the operation knob is pushed, a manual down command signal is output by bringing the first movable contact into contact with the down fixed contact with the second movable contact out of contact with the auto fixed contact, and an auto down command signal is output by bringing the second movable contact into contact with the auto fixed contact with the first movable contact in contact with the down fixed contact; and when the operation knob is pulled, a manual up command signal is output by bringing the second movable contact into contact with the up fixed contact with the first movable contact out of contact with the auto fixed contact, and an auto up command signal is output by bringing the first movable contact into contact with the auto fixed contact with the second movable contact in contact with the up fixed contact.

3. The switch apparatus according to claim 1, wherein the auto fixed contact is provided at a position equidistant from the down fixed contact and the up fixed contact, and the first movable contact and the second movable contact are disposed at positions equidistant from the auto fixed contact when the operation knob is not operated.

4. The switch apparatus according to claim 1, wherein the common fixed contact extends from the side of the down fixed contact to the side of the up fixed contact, the normally-closed movable contacts include a third movable contact and a fourth movable contact, and the third and fourth movable contacts and the first and second movable contacts are distributed substantially at the four corners of a rectangle.
